(19) United States
(12) Patent Application Publication
(10) Pub. No.: US 2016/0381349 A1
(43) Pub. Date: Dec. 29, 2016

(54) SYSTEM FOR CONTROLLING CAMERA RIG FOR CAPTURING STEREOGRAPHIC IMAGE HAVING LOW SIGNAL PROCESSING ERROR RATE

(71) Applicant: REDROVER CO., LTD., Seongnam-si (KR)

(72) Inventors: Jung Il PARK, Seongnam-si (KR); Young Hun KIM, Yongin-si (KR); Dong Soo KIM, Gwangju-si (KR); Jun Woo SEOUNG, Seongnam-si (KR)

(21) Appl. No.: 14/754,350

(22) Filed: Jun. 29, 2015

(51) Int. Cl. H04N 13/02

(52) U.S. Cl. CPC H04N 13/0296; H04N 13/0239

(57) ABSTRACT

The present invention relates generally to systems for controlling camera rigs. More particularly, the present invention relates to a system for controlling a camera rig that controls, using motors, the positions and orientations of a left-eye camera and a right-eye camera to capture a stereographic image. The system can more precisely and inexpensively process signals generated from the motors.

The present invention provides a system for controlling a camera rig that provides an improved method of processing signals generated from the motors or the encoders, thereby minimizing error that may be caused by noise or the like while signals for controlling the motors are processed.

### BACKGROUND OF THE INVENTION

1. Field of the Invention

The present invention relates generally to systems for controlling camera rigs. More particularly, the present invention relates to a system for controlling a camera rig that controls, using motors, the positions and orientations of a left-eye camera and a right-eye camera to capture a stereographic image. The system can more precisely and inexpensively process signals generated from the motors.

2. Description of the Related Art

Generally, a left-eye image and a right-eye image must be captured in order to obtain a stereographic image. Furthermore, the positions and orientations of the left- and right-eye images must be adjustable so that the distance therebetween, the angle relative to each other, etc. can be adjusted. To achieve the above-mentioned purposes, there is the need for an apparatus on which a left-eye camera for capturing a left-eye image and a right-eye camera for capturing a right-eye image are movably installed. This apparatus is typically called a stereographic camera rig.

FIG. 1 is a view showing a conventional stereographic camera rig. Referring to FIG. 1, a left-eye camera 20 and a right-eye camera 30 are installed in a stereographic camera rig 10 provided with a half mirror 40. The cameras 20 and 30 capture images of a target that pass through or are reflected by the half mirror 60.

The positions and orientations, i.e. roll and pitch, of the cameras are adjusted so as to precisely align a left-eye image and a right-eye image with each other. For this, the conventional stereographic camera rig may use a goniometer (dovetail module) or a plurality of motors to rotate (i.e. adjust the pitch of) each camera around a y-axis.

FIG. 2 is a block diagram showing the configuration of a conventional camera control apparatus using motors.

Referring to FIG. 2, to adjust the roll and pitch of cameras using motors, there is the need for circuits such as encoders 22, signal generators 23, and signal counters 24. The encoders 22 output encoder signals corresponding to the RPMs of the respective motors 21 in order to control the motors 21. Each signal generator 23 creates and outputs a rotation sensing pulse at the rising edge or the falling edge of an encoder signal generated from the corresponding encoder. Each signal counter 24 counts the number of rotation sensing pulses created from the corresponding signal generator 23 and creates a count value.

In the conventional camera control apparatus having the above-mentioned configuration, each motor 21 includes the circuits such as the encoder 22, the signal generator 23, and the signal counter 24. In addition, each of the encoder 22, the signal generator 23, and the signal counter 24 is embodied by a separate semiconductor chip.

Therefore, to embody the conventional camera control apparatus, required are a comparatively large number of elements including the several motors, along with an encoder chip, a signal generator chip, and a signal counter chip, which are required for each motor. Thus, the overall volume of the apparatus must be comparatively large in order to dispose therein all of the above-mentioned elements. Consequently, there are problems in that the camera control apparatus is large and heavy, and the production cost is also increased.

Furthermore, in the conventional camera control apparatus using the several motors to adjust the roll or pitch of the cameras, errors may be caused by a variety of noise signals while processing signals such as encoder signals for controlling the motors. Because of such errors, controlling the motors may not be reliably conducted. Therefore, required is a camera rig control system that can reduce errors caused by noise signals while processing signals for controlling the motors.

### SUMMARY OF THE INVENTION

Accordingly, the present invention has been made keeping in mind the above problems occurring in the prior art, and an object of the present invention is to provide a system for controlling a camera rig that is configured such that a single signal generator integrally processes encoder signals created from a plurality of motors, unlike the conventional technique, in which circuit elements such as signal generators and signal counters are installed in respective motors in the form of separate chips, and a single signal counter can process signals generated from the integrated signal generators without the need for signal counters provided in the respective motors, whereby the structure of the system can be simple, and the production cost thereof can be reduced.

Another object of the present invention is to provide a system for controlling a camera rig that provides an improved method of processing signals generated from the motors or the encoders, thereby minimizing error that may be caused by noise or the like while signals for controlling the motors are processed.

In order to accomplish the above object, the present invention provides a system for controlling a camera rig for capturing a stereographic image, including: a camera rig body on which a left-eye camera for capturing a left-eye image and a right-eye camera for capturing a right-eye image are installed; a left-eye stage connecting the left-eye camera to the camera rig body, the left-eye stage being configured to adjust a position and an image-capturing direction of the left-eye camera; a right-eye stage connecting the right-eye camera to the camera rig body, the right-eye stage being configured to adjust a position and an image-capturing direction of the right-eye camera; and a motor control device creating control signals corresponding to variation in the positions and the image-capturing directions of the left- and right-eye cameras and transmitting the control signals to the left- and right-eye stages to control movement of the left- and right-eye stages, wherein the left-eye stage comprises: a left-eye motor unit including a plurality of motors and adjusting the position and the image-capturing direction of the left-eye camera; a left-eye encoder unit including a plurality of encoders installed in the respective motors of the left-eye motor unit, each encoder sensing rotation of the corresponding motor, converting a sensed signal into an encoder signal, and creating an encoder signal containing information about a number of rotations of the corresponding motor; a left-eye signal generator receiving encoder signals generated from the encoders of the left-eye encoder unit and creating and outputting a phase change pulse signal whenever a phase change of a rising edge or a falling edge of each of the encoder signals occurs; and a left-eye signal counter counting a number of phase change pulse signals of each encoder generated from the left-eye signal generator and using a resultant count value to recognize a degree by which the corresponding motor is rotated, wherein the phase change pulse signal comprises a pulse signal having a rising edge at a rising or falling edge of the encoder signal and having a falling edge at a subsequent rising or falling edge of the encoder signal.

In a preferred embodiment of this invention, the left-eye encoder unit creates encoder signals of two channels, and the signal generator does not create the phase change pulse signal when the encoder signals of the two channels of the left-eye encoder unit simultaneously form rising edges or falling edges.

In a preferred embodiment of this invention, when the signal generator does not create the phase change pulse signal, a user is notified thereof by an alert.

In order to accomplish the above object, the present invention further provides a system for controlling a camera rig for capturing a stereographic image, comprising: a camera rig body on which a left-eye camera for capturing a left-eye image and a right-eye camera for capturing a right-eye image are installed; a left-eye stage connecting the left-eye camera to the camera rig body, the left-eye stage being configured to adjust a position and an image-capturing direction of the left-eye camera; a right-eye stage connecting the right-eye camera to the camera rig body, the right-eye stage being configured to adjust a position and an image-capturing direction of the right-eye camera; and a motor control device creating control signals corresponding to variation in the positions and the image-capturing directions of the left- and right-eye cameras and transmitting the control signals to the left- and right-eye stages to control movement of the left- and right-eye stages, wherein the left-eye stage comprises: a plurality of motors adjusting the position and the image-capturing direction of the left-eye camera; and a plurality of encoders installed in the respective motors, each encoder sensing rotation of the corresponding motor, converting a sensed signal into an encoder signal, and creating an encoder signal containing information about a number of rotations of the corresponding motor; a plurality of signal generators receiving encoder signals generated from the respective encoders, each of the signal generators creating and outputting a phase change pulse signal whenever a phase change of a rising edge or a falling edge of the corresponding encoder signal occurs; and a plurality of signal counters each counting a number of phase change pulse signals of the associated encoder generated from the corresponding left-eye signal generator and using a resultant count value to recognize a degree by which the corresponding motor is rotated, wherein the phase change pulse signal comprises a pulse signal having a rising edge at a rising or falling edge of the encoder signal and having a falling edge at a subsequent rising or falling edge of the encoder signal.

In order to accomplish the above object, the present invention further provides a system for controlling a camera rig for capturing a stereographic image, comprising: a camera rig body on which a left-eye camera for capturing a left-eye image and a right-eye camera for capturing a right-eye image are installed; a left-eye stage connecting the left-eye camera to the camera rig body, the left-eye stage being configured to adjust a position and an image-capturing direction of the left-eye camera; a right-eye stage connecting the right-eye camera to the camera rig body, the right-eye stage being configured to adjust a position and an image-capturing direction of the right-eye camera; and a motor control device creating control signals corresponding to variation in the positions and the image-capturing directions of the left- and right-eye cameras and transmitting the control signals to the left- and right-eye stages to control movement of the left- and right-eye stages, wherein the left-eye stage comprises: a plurality of motors adjusting the position and the image-capturing direction of the left-eye camera; a plurality of encoders installed in the respective motors, each encoder sensing rotation of the corresponding motor, converting a sensed signal into an encoder signal, and creating an encoder signal containing information about a number of rotations of the corresponding motor; a plurality of signal generators receiving encoder signals generated from the respective encoders, each of the signal generators creating and outputting a phase change pulse signal whenever a phase change of a rising edge or a falling edge of the corresponding encoder signal occurs; and a plurality of signal counters each counting a number of phase change pulse signals of the associated encoder generated from the corresponding left-eye signal generator and using a resultant count value to recognize a degree by which the corresponding motor is rotated, wherein each of the encoders creates encoder signals of two channels, and each of the signal generators does not create the phase change pulse signal when the encoder signals of the two channels of the corresponding encoder simultaneously form rising edges or falling edges.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the configuration of a conventional system for controlling a camera rig;

FIG. 2 is a block diagram showing the configuration of a conventional camera control apparatus using a motor;

FIG. 3 is a perspective view illustrating a stereographic camera rig provided with a system for controlling a camera rig for capturing a stereographic image according to an embodiment of the present invention;

FIG. 4 is a view illustrating the configuration of the camera rig control system according to the embodiment of the present invention;

FIG. 5 is a view showing examples of signals generated from an encoder and a left-eye signal generator of FIG. 4;

FIG. 6 is a view showing other examples of signals generated from the encoder and the left-eye signal generator of FIG. 4.

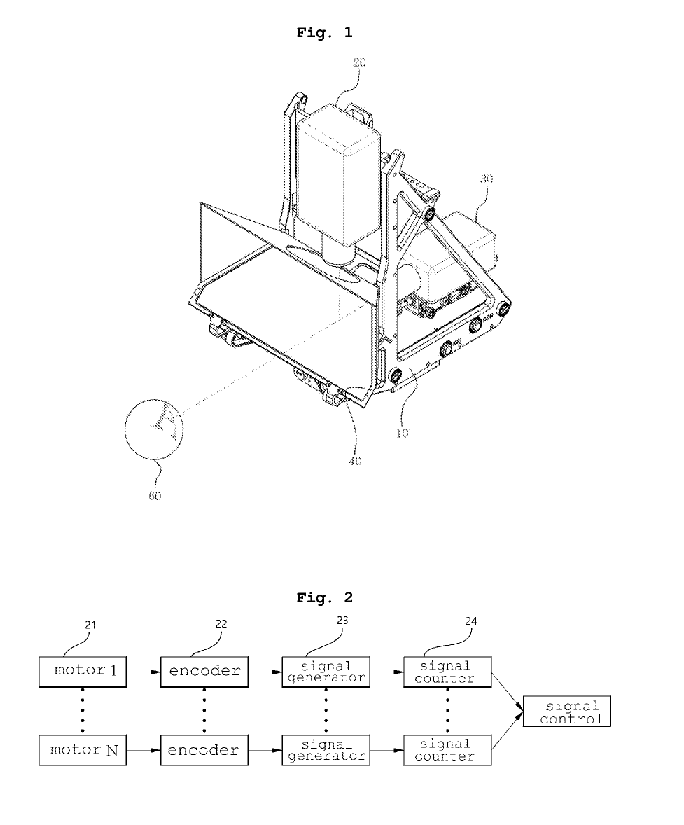

### DESCRIPTION OF THE PREFERRED EMBODIMENTS

Hereinafter, exemplary embodiments of the present invention will be described in detail with reference to the attached drawings. However, the present invention is not limited to the exemplary embodiments. The same reference numerals are used throughout the different drawings to designate the same or similar components.

To embody a stereographic image, there is the need for a left-eye image and a right-eye image, which are separately captured. Capturing the separate left- and right-eye images requires the use of a stereographic image capturing system that includes a left-eye camera for capturing the left-eye image and a right-eye camera for capturing the right-eye image.

As such, two cameras including the left-eye camera and the right-eye camera are required to capture a stereographic image. A user must be able to easily move and control the two cameras. Particularly, the user must also control the position and orientation of each of the left- and right-eye cameras and the relative positions and orientations of the left- and right-eye cameras.

For this, there is the need for a rig on which the two cameras can be installed. In addition, the two cameras installed on the rig must be able to move on the rig without restriction during an image capturing process.

Exemplary embodiments of the present invention introduce a system for controlling a camera rig for capturing a stereographic image that can achieve the above-mentioned purposes.

### First Embodiment

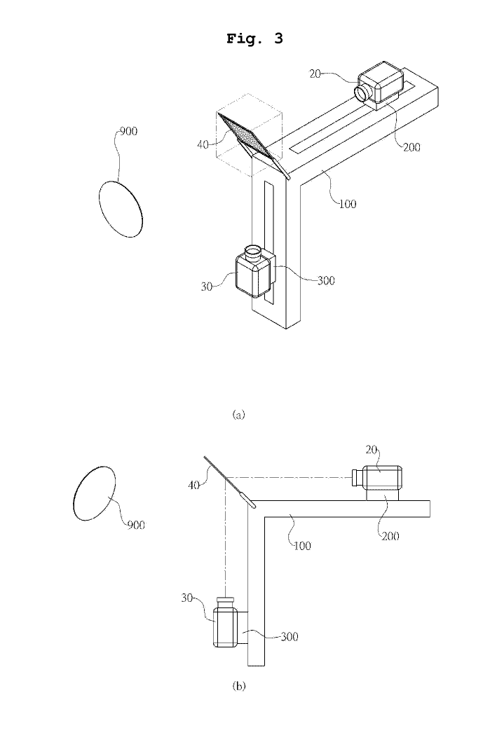

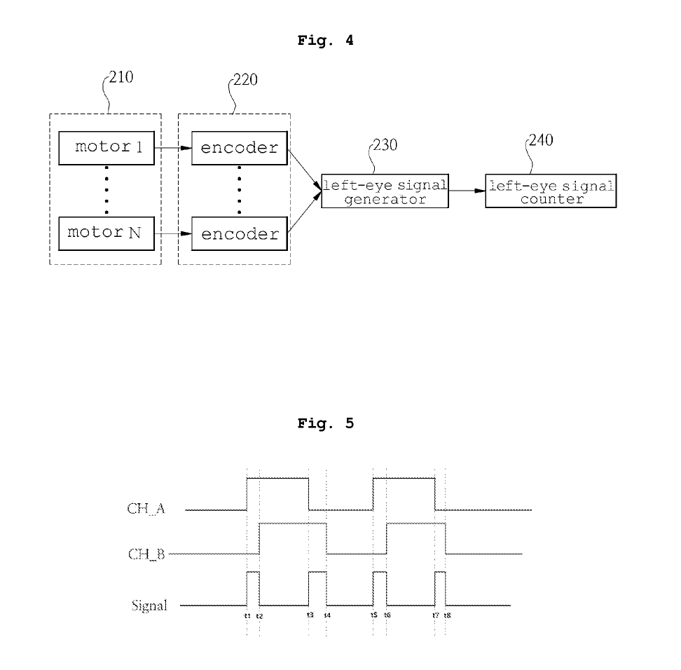

FIG. 3 is a perspective view illustrating a stereographic camera rig provided with a system for controlling a camera rig for capturing a stereographic image according to a first embodiment of the present invention. FIG. 4 is a view illustrating the configuration of the camera rig control system according to the first embodiment of the present invention. FIG. 5 is a view showing examples of signals generated from an encoder and a left-eye signal generator of FIG. 4.

Referring to the drawings, the camera rig control system according to the first embodiment of the present invention includes a camera rig body 100, a left-eye stage 200, a right-eye stage 300 and a motor control device.

The left-eye stage 200 and the right-eye stage 300 are mounted to the camera rig body 100. Furthermore, a half mirror is installed on the camera rig body 100 so that images entering a left-eye camera 20 and a right-eye camera 30 are transmitted through or reflected by the half mirror.

The left-eye stage 200 is a device by which the left-eye camera 20 can be mounted to the camera rig body 100. Consequently, the position and orientation of the left-eye camera 20 can be adjusted by adjusting the position and orientation of the left-eye stage 200 on which the left-eye camera 20 is installed.

The right-eye stage 300 has the same configuration and function as those of the left-eye stage 200.

The motor control device creates control signals corresponding to variation in the positions and image-capturing directions of the left- and right-eye cameras 20 and 30, and transmits the control signals to the left- and right-eye stages 200 and 300. In addition, the motor control device receives from the left- and right-eye stages 200 and 300 signals corresponding to variation in the positions and image-capturing directions of the left- and right-eye cameras 20 and 30, and creates information about the positions and image-capturing directions of the left- and right-eye cameras 20 and 30.

In order to create a stereographic image requires the control of an interocular distance (IOD), which is the relative distance between the two cameras, that is, the left-eye camera 20 and the right-eye camera 30, the convergence pertaining to adjusting the focal distance of each of the two cameras, and the focal distances of lenses. The reason for this is because the three-dimensional effect of the created stereographic image depends on the above values. Moreover, the positions and image-capturing directions of the left- and right-eye cameras 20 and 30 are determined by the values of the two cameras that pertain to creating the stereographic image.

When specific values for the position and image-capturing direction of each camera are present, the motor control device transmits controls signals corresponding to the specific values to the left- and right-eye stages 200 and 300.

The motor control device uses motors installed in the left-eye stage 200 and the right-eye stage 300 and thus adjusts the positions and the orientations of the left- and the right-eye stages 200 and 300 such that the positions and the image-capturing directions of the left- and right-eye cameras 20 and 30 correspond to control signals transmitted from the motor control device.

Furthermore, the motor control device receives, from the motors installed in the left- and right-eye stages 200 and 300, information about rotation of the motors.

The left-eye camera 20 and the right-eye camera 30 are respectively coupled to the left-eye stage 200 and the right-eye stage 300, and are thus synchronized with the operation of the left-eye stage 200 and the right-eye stage 300.

Therefore, through information about the rotation of the motors installed in the left- and right-eye stages 200 and 300, information about the positions and orientations of the left- and right-eye cameras 20 and 30, which are respectively coupled to the left- and right-eye stages 200 and 300, can be known.

The left-eye stage 200 includes a left-eye motor unit 210, a left-eye encoder unit 220, a left-eye signal generator 230, and a left-eye signal counter 240. Furthermore, although it is not shown in the drawings, the left-eye stage 200 includes a left-eye frame, which includes a left-eye stage casing and mechanical elements which are installed in the casing to couple the corresponding camera to the left-eye stage 200.

The left-eye motor unit 210 comprises a plurality of motors. The position and the image-capturing direction of the left-eye camera 20 are controlled by rotation of the motors.

The left-eye encoder unit 220 comprises a plurality of encoders which are installed in the respective motors. Each encoder creates an encoder signal corresponding to the rotation of the associated motor.

The left-eye signal generator 230 receives encoder signals generated from the encoders of the left-eye encoder unit 220 and creates a phase change pulse signal.

The phase change pulse signal created from the left-eye signal generator 230 is a pulse signal that has a rising edge at a rising or falling edge of the encoder signal, and has a falling edge at a falling or rising edge of the subsequent encoder signal.

Referring to FIG. 5, in the encoder signal having two channels including channel A and channel B, the phase change pulse signal has a rising edge at a rising edge (t1) of a channel-A signal CH_A. At a rising edge (t2) of a channel-B signal CH_B, which is the other channel signal of the encoder signal, the phase change pulse signal has a falling edge. At a falling edge (t3) of the channel-A signal CH_A of the encoder signal, the phase change pulse signal has a rising edge again. At a falling edge of the channel-B signal CH_B of the encoder signal, the phase change pulse signal has a falling edge (t4).

### Second Embodiment

A system for controlling a camera rig for capturing a stereographic image according to a second embodiment of the present invention is characterized in that when encoder signals of two channels in the left-eye signal generator 230 are simultaneously rising edges or falling edges, a phase change pulse is not created.

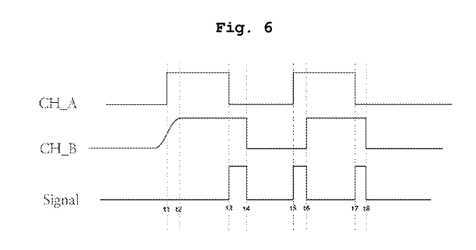

Referring to FIG. 6, the left-eye encoder unit 220 creates encoder signals CH_A and CH_B of two channels. Under normal conditions, at the time point t2, a predetermined time after the time point t1, at which the rising edge of the channel-A signal CH-A of the encoder signals is created, the rising edge of the channel-B signal CH_B of the encoder signals is created. Every time each of the channel-A signal CH-A and the channel-B signal CH_B of the encoder signals forms a rising edge, the left-eye signal generator 230 must detect the rising edge and create a pulse signal, or change the rising edge and the falling edge. However, for various reasons, noise may be present in the signals. Because of the noise, unlike the case of FIG. 5, the channel-B signal CH_B of the encoder signals begins to be created before the time point t1, prior to the time point at which the rising edge of the channel-B signal CH_B must be formed, whereby a high signal having a level similar to the rising edge of the pulse may already have been generated at the time point t1.

In this case, when the left-eye signal generator 230 creates a corresponding phase change pulse signal, the left-eye signal counter 240 cannot distinguish whether the phase change pulse signal is the rising edge of the channel-A signal CH-A of the encoder signals or the rising edge of the channel-B signal CH-B thereof. Furthermore, this means that the timing at which a phase change of the phase change pulse signal must be conducted is missed. Therefore, in the second embodiment of the present invention, when the rising edge of the channel-A encoder signal CH-A and the rising edge of the channel-B encoder signal CH-B are simultaneously detected, the left-eye signal generator 230 disregards the corresponding encoder signals, recognizes the signal detected at this time as an error signal, and thus passes it without creating a separate corresponding phase change pulse signal.

Furthermore, in the second embodiment of the present invention, when an error signal is recognized, the user is notified thereof by an alert so that the user can recognize the presence of the error signal and correct it.

### Third Embodiment

The first embodiment has introduced the signal processing method of the left-eye signal generator 230 of the camera rig control system, which can be inexpensively embodied because the single signal generator and the single left-eye signal counter 240 can process all signals generated from the several motors in the same manner as that of the first embodiment.

However, the conventional rig control system, in which each motor 21 includes a signal generator 23 and a signal counter 24, may also use the left-eye signal generator introduced in the first or second embodiment and enhance the accuracy of a signal.

The third embodiment according to the present invention proposes a camera rig control system having such characteristics.

In the third embodiment of the present invention, the signal generator 23 of the camera rig control system of FIG. 2 creates a phase change pulse signal having, as shown in FIG. 5, a rising edge at a rising or falling edge of an encoder signal and a falling edge at a rising or falling edge of a subsequent encoder signal in the same manner as that of the left-eye signal generator 230 of the first embodiment.

Furthermore, in the third embodiment of the present invention, the signal generator 23 of the camera rig control system of FIG. 2 does not create a phase change pulse when encoder signals of two channels simultaneously have rising edges or falling edges in the same manner as that of the left-eye signal generator 230 of the third embodiment, as shown in FIG. 6.

As described above, a system for controlling a camera rig according to the present invention is configured such that a single signal generator and a single signal counter can process signals generated from motors and encoders, rather than having a structure such that each motor has a separate signal generator and signal counter for processing encoder signals. Therefore, the camera rig control system can have a simple structure, whereby the production cost thereof can be reduced.

Furthermore, the camera rig control system can process encoder signals generated from the encoders without causing an error, and thus can precisely control the position and orientation of a left-eye camera and a right-eye camera installed on the camera rig.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for controlling a camera rig for capturing a stereographic image, comprising:
a camera rig body on which a left-eye camera for capturing a left-eye image and a right-eye camera for capturing a right-eye image are installed;
a left-eye stage connecting the left-eye camera to the camera rig body, the left-eye stage being configured to adjust a position and an image-capturing direction of the left-eye camera;
a right-eye stage connecting the right-eye camera to the camera rig body, the right-eye stage being configured to adjust a position and an image-capturing direction of the right-eye camera; and
a motor control device creating control signals corresponding to variation in the positions and the image-capturing directions of the left- and right-eye cameras and transmitting the control signals to the left- and right-eye stages to control movement of the left- and right-eye stages,
wherein the left-eye stage comprises:
a left-eye motor unit including a plurality of motors and adjusting the position and the image-capturing direction of the left-eye camera;
a left-eye encoder unit including a plurality of encoders installed in the respective motors of the left-eye motor unit, each encoder sensing rotation of the corresponding motor, converting a sensed signal into an encoder signal, and creating an encoder signal containing information about a number of rotations of the corresponding motor;
a left-eye signal generator receiving encoder signals generated from the encoders of the left-eye encoder unit and creating and outputting a phase change pulse signal whenever a phase change of a rising edge or a falling edge of each of the encoder signals occurs; and
a left-eye signal counter counting a number of phase change pulse signals of each encoder generated from the left-eye signal generator and using a resultant count value to recognize a degree by which the corresponding motor is rotated,
wherein the phase change pulse signal comprises a pulse signal having a rising edge at a rising or falling edge of the encoder signal and having a falling edge at a subsequent rising or falling edge of the encoder signal.

2. The system as set forth in claim 1, wherein the left-eye encoder unit creates encoder signals of two channels, and the signal generator does not create the phase change pulse signal when the encoder signals of the two channels of the left-eye encoder unit simultaneously form rising edges or falling edges.

3. The system as set forth in claim 2, wherein when the signal generator does not create the phase change pulse signal, a user is notified thereof by an alert.

4. A system for controlling a camera rig for capturing a stereographic image, comprising:
a camera rig body on which a left-eye camera for capturing a left-eye image and a right-eye camera for capturing a right-eye image are installed;
a left-eye stage connecting the left-eye camera to the camera rig body, the left-eye stage being configured to adjust a position and an image-capturing direction of the left-eye camera;
a right-eye stage connecting the right-eye camera to the camera rig body, the right-eye stage being configured to adjust a position and an image-capturing direction of the right-eye camera; and
a motor control device creating control signals corresponding to variation in the positions and the image-capturing directions of the left- and right-eye cameras and transmitting the control signals to the left- and right-eye stages to control movement of the left- and right-eye stages,
wherein the left-eye stage comprises:
a plurality of motors adjusting the position and the image-capturing direction of the left-eye camera; and
a plurality of encoders installed in the respective motors, each encoder sensing rotation of the corresponding motor, converting a sensed signal into an encoder signal, and creating an encoder signal containing information about a number of rotations of the corresponding motor;
a plurality of signal generators receiving encoder signals generated from the respective encoders, each of the signal generators creating and outputting a phase change pulse signal whenever a phase change of a rising edge or a falling edge of the corresponding encoder signal occurs; and
a plurality of signal counters each counting a number of phase change pulse signals of the associated encoder generated from the corresponding left-eye signal generator and using a resultant count value to recognize a degree by which the corresponding motor is rotated,
wherein the phase change pulse signal comprises a pulse signal having a rising edge at a rising or falling edge of the encoder signal and having a falling edge at a subsequent rising or falling edge of the encoder signal.

5. A system for controlling a camera rig for capturing a stereographic image, comprising:
a camera rig body on which a left-eye camera for capturing a left-eye image and a right-eye camera for capturing a right-eye image are installed;
a left-eye stage connecting the left-eye camera to the camera rig body, the left-eye stage being configured to adjust a position and an image-capturing direction of the left-eye camera;
a right-eye stage connecting the right-eye camera to the camera rig body, the right-eye stage being configured to adjust a position and an image-capturing direction of the right-eye camera; and
a motor control device creating control signals corresponding to variation in the positions and the image-capturing directions of the left- and right-eye cameras and transmitting the control signals to the left- and right-eye stages to control movement of the left- and right-eye stages,
wherein the left-eye stage comprises:
a plurality of motors adjusting the position and the image-capturing direction of the left-eye camera;
a plurality of encoders installed in the respective motors, each encoder sensing rotation of the corresponding motor, converting a sensed signal into an encoder signal, and creating an encoder signal containing information about a number of rotations of the corresponding motor;
a plurality of signal generators receiving encoder signals generated from the respective encoders, each of the signal generators creating and outputting a phase change pulse signal whenever a phase change of a rising edge or a falling edge of the corresponding encoder signal occurs; and
a plurality of signal counters each counting a number of phase change pulse signals of the associated encoder generated from the corresponding left-eye signal generator and using a resultant count value to recognize a degree by which the corresponding motor is rotated,
wherein each of the encoders creates encoder signals of two channels, and
each of the signal generators does not create the phase change pulse signal when the encoder signals of the two channels of the corresponding encoder simultaneously form rising edges or falling edges.
